(19) United States
(12) Patent Application Publication
(10) Pub. No.: US 2019/0378489 A1
(43) Pub. Date: Dec. 12, 2019

(54) SOUNDPROOF STRUCTURE

(71) Applicant: FUJIFILM Corporation, Tokyo (JP)

(72) Inventors: Masayuki NAYA, Ashigara-kami-gun (JP); Shinya HAKUTA, Ashigara-kami-gun (JP); Shogo YAMAZOE, Ashigara-kami-gun (JP)

(73) Assignee: FUJIFILM Corporation, Tokyo (JP)

(21) Appl. No.: 16/550,434

(22) Filed: Aug. 26, 2019

Related U.S. Application Data
(63) Continuation of application No. PCT/JP2018/012064, filed on Mar. 26, 2018.

(30) Foreign Application Priority Data
Mar. 28, 2017 (JP) 2017-063224

(51) Int. Cl. G10K 11/162

(52) U.S. Cl. CPC G10K 11/162

(57) ABSTRACT

There is provided a soundproof structure that can not only have a peak of noise absorption at a specific frequency but also have a spread at the peak in order to suppress noise with a specific frequency.

A soundproof cell includes a frame having a hole portion penetrating through both surfaces and at least one film fixed to at least one surface of the frame. The soundproof cell is disposed in an opening portion of a wall separating two spaces from each other in a state in which a surface of the film is inclined with respect to an opening cross section of the opening portion to provide a ventilation portion. All the surfaces of the at least one film are separated from the wall surface. A distance between the surface of the film on the side of the wall surface of the opening portion and the wall surface is 0.1 mm or more and is a distance set according to an absorption peak frequency at a spectral peak of soundproofing.

### CROSS-REFERENCE TO RELATED APPLICATIONS

This application is a Continuation of PCT International Application No. PCT/JP2018/012064 filed on Mar. 26, 2018, which claims priority under 35 U.S.C. § 119(a) to Japanese Patent Application No. 2017-063224 filed on Mar. 28, 2017. The above application is hereby expressly incorporated by reference, in its entirety, into the present application.

### BACKGROUND OF THE INVENTION

### 1. Field of the Invention

The present invention relates to a soundproof structure comprising a frame and a film fixed to the frame. More specifically, the present invention relates to a soundproof structure in which one or a plurality of soundproof cells having a film fixed to one or both surfaces of a frame are disposed within an opening portion, such as a duct, to selectively and strongly shield the sound with a target frequency.

### 2. Description of the Related Art

In recent years, a soundproof structure has been proposed in which a soundproof cell, in which a film such as a sheet, a film, or a thin plate serving as a vibrating body is bonded to a frame, is disposed in a soundproof space (refer to WO2017/030208A, JP5326472B, and JP5386920B). Such a sound insulation structure can have high shielding performance at a specific frequency compared with conventional sound insulation members. In addition, it is possible to control the sound insulation frequency by changing the shape of the frame and the stiffness of the film.

WO2017/030208A relevant to the application of this applicant discloses a soundproof structure body which has a soundproof cell comprising a frame and a film fixed to one surface or both surfaces of the frame and in which the soundproof cell is disposed in an opening member in a state in which the film surface of the film is inclined with respect to the opening cross section of the opening member and a region serving as a ventilation hole through which gas passes is provided in the opening member.

According to WO2017/030208A, even with a high opening ratio, a large soundproofing effect can be achieved. Therefore, at the time of attaching the soundproof cell, noise can be removed and high air permeability can be maintained without adding a duct and a cylinder.

JP5326472B discloses a sound absorbing structure which has a sound absorbing body comprising a housing having an opening portion and a plate-shaped or film-shaped vibrating portion, which is provided in the opening portion and defines an air layer closed in the housing, in which the sound absorbing body is disposed so that the vibrating portion faces the room boundary of the sound field and the space formed between the vibrating portion and the room boundary is connected to the sound field. Assuming that the basic vibration frequency of the bending system due to the elastic vibration of the vibrating portion is fa and the resonance frequency of the spring-mass system by the mass component of the vibrating portion and the spring component of the air layer is fb, 0.05≤fa/fb≤0.65 is satisfied.

According to JP5326472B, it is possible to efficiently absorb low-pitched sound while suppressing the thickness of the air layer.

JP5386920B discloses a sound absorbing structure body including a plate sound absorbing body that has a housing having an opening portion and a bottom portion and a plate-shaped or film-shaped vibrating body that closes the opening portion of the housing to define the air layer, serves as a sound receiving portion, and faces an outer panel. The basic vibration frequency of the elastic vibration of the vibrating body is assumed to be in the range of 5% to 65% of the resonance frequency of the spring-mass system configured to include the mass of the vibrating body and the spring component of the air layer.

According to JP5386920B, it is possible to efficiently absorb low-frequency sound, such as road noise.

### SUMMARY OF THE INVENTION

The soundproof cell of the soundproof structure disclosed in WO2017/030208A is a film type sound absorbing material, and is a sound absorbing body of a resonance system in which the absorption characteristics are determined by the film and the back space. Such a sound absorbing body has a feature that the absorbance is large at the peak of sound absorption but the width of the peak is narrow. For this reason, such a sound absorbing body can be generally used for suppression of noise with a specific frequency due to resonant vibration of a machine.

However, machines and the like have the following problems that individual differences or aged changes cannot be avoided.

1. Since slight stiffness and weight deviations due to individual differences change the resonance frequency, the individual difference in the resonance frequency of the machine is large. Therefore, it is difficult to deal with a plurality of machines with a narrow peak width.

2. The resonance frequency gradually changes with age mainly in a case where the cause of noise is a movable unit, such as a fan or a pump.

In addition, in the soundproof structure disclosed in WO2017/030208A, there is a problem that, in a case where the soundproof cell comprising the film on both surfaces of the frame is provided so as to be in close contact with the wall surface of the opening member, the sound absorption effect of the film surface on one side cannot be utilized and accordingly the efficiency is low.

On the other hand, in the sound absorbing structure and the sound absorbing structure body (hereinafter, represented by the sound absorbing structure) disclosed in JP5326472B and JP5386920B, in a case where the sound absorbing structure is attached to various members of a vehicle body structure, for example, a member such as a floor, a front pillar, a rear pillar, a roof, or a dash panel in order to absorb noise inside a vehicle or the like, a space is formed between the vibrating portion and the outer panel by attaching the sound absorbing body to the inner panel so that the vibrating portion of the sound absorbing body faces the outer panel serving as a room boundary or by attaching the vibrating portion of the sound absorbing body to the outer panel using a columnar member, a spacer, or the like, a communication hole that communicates with the inside of the vehicle is provided in the inner panel in order to make the space communicate with the sound field (vehicle interior), and sound entering the space between the room boundary and the vibrating portion is absorbed by the vibration of the vibrating portion. In addition, in the sound absorbing structures disclosed in JP5326472B and JP5386920B, the distance between the room boundary and the vibrating portion can be freely changed by using an expandable columnar member. However, in the sound absorbing structures disclosed in JP5326472B and JP5386920B, a space where the sound absorbing structure, which includes a space where sound absorption between the vibrating portion and the room boundary occurs, is disposed is a closed space except for the communication hole that communicates with the vehicle interior that is the sound field. For this reason, there is a problem that the sound absorbing structures cannot be applied for soundproofing that requires air permeability, such as a duct.

In order to solve the aforementioned problems of the conventional techniques, it is an object of the present invention to provide a soundproof structure in which a soundproof cell serving as a sound absorbing body is disposed in an opening portion of a structure that requires air permeability, such as a duct, and the separation distance between the inner wall surface of the opening portion and the film surface of the soundproof cell can be a distance according to the cutoff frequency of the sound to be soundproofed that passes through the opening portion.

In order to achieve the aforementioned object, a soundproof structure of the present invention is a soundproof structure comprising a soundproof cell including a frame having a hole portion penetrating through both opposite surfaces and at least one film fixed to at least one surface of the frame. The soundproof cell is disposed in an opening portion of a wall separating two spaces from each other in a state in which a surface of the at least one film is inclined with respect to an opening cross section of the opening portion to provide a ventilation portion. A surface of a film on a side of a wall surface of the opening portion in the at least one film has a portion separated from the wall surface. A distance between the surface of the film on the side of the wall surface of the opening portion and the wall surface is 0.1 mm or more and is a distance set according to an absorption peak frequency at a spectral peak of soundproofing.

Here, it is preferable that the distance between the surface of the film on the side of the wall surface of the opening portion and the wall surface is 20 mm or less.

It is preferable that the at least one film is two films fixed to both surfaces of the frame.

It is preferable that the absorption peak frequency decreases as the distance between the surface of the film on the side of the wall surface of the opening portion and the wall surface decreases.

It is preferable that a spacer is provided between the surface of the film on the side of the wall surface of the opening portion and the wall surface, the soundproof cell is fixed to the wall surface through the spacer, and the spacer has a gap with at least one portion through which sound from an outside enters.

It is preferable that the spacer is a plurality of columnar bodies.

It is preferable that sound is incident from one opening end of the opening portion and propagates to exit from the other opening end and that the spacer is a plurality of plate-shaped bodies.

It is preferable that the plate-shaped bodies are disposed so as to face an incidence direction of the sound.

It is preferable that the plate-shaped bodies are disposed along an incidence direction of the sound.

It is preferable that the spacer and the soundproof cell are formed as an integrated structure.

It is preferable that the distance between the surface of the film on the side of the wall surface of the opening portion and the wall surface is adjustable.

It is preferable that an angle between the surface of the film on the side of the wall surface of the opening portion and the wall surface is adjustable.

According to the present invention, in the soundproof structure in which the sound absorbing body is disposed in the opening portion such as a duct, the separation distance between the inner wall surface of the opening portion and the film surface of the soundproof cell serving as a sound absorbing body can be a distance according to the cutoff frequency of the sound to be soundproofed that passes through the opening portion.

### BRIEF DESCRIPTION OF THE DRAWINGS

FIG. 1 is a conceptual front view of a soundproof structure according to the present invention as viewed from the sound source side.

FIG. 2 is a conceptual side sectional view of the soundproof structure shown in FIG. 1.

FIG. 3 is a partially broken perspective view schematically showing an example of a soundproof structure according to an embodiment of the present invention.

FIG. 4 is a schematic partial side sectional view showing the arrangement state of a soundproof cell in an opening portion of the soundproof structure shown in FIG. 3.

FIG. 5 is a schematic front view of the soundproof structure shown in FIG. 3.

FIG. 6 is a bottom view of the soundproof cell of the soundproof structure shown in FIG. 3 as viewed from the spacer side.

FIG. 7 is a schematic partial side sectional view showing the arrangement state of a soundproof cell in an opening portion in another example of the soundproof structure of the present invention.

FIG. 8 is a schematic front view of the soundproof structure shown in FIG. 7.

FIG. 9 is a bottom view of the soundproof cell of the soundproof structure shown in FIG. 7 as viewed from the spacer side.

FIG. 10 is a bottom view of a soundproof cell of another example of the soundproof structure of the present invention as viewed from the spacer side.

FIG. 11 is a bottom view of a soundproof cell of another example of the soundproof structure of the present invention as viewed from the spacer side.

FIG. 12 is a bottom view of a soundproof cell of another example of the soundproof structure of the present invention as viewed from the spacer side.

FIG. 13 is a bottom view of a soundproof cell of another example of the soundproof structure of the present invention as viewed from the spacer side.

FIG. 14 is a schematic partial side sectional view showing the arrangement state of a soundproof cell in an opening portion in another example of the soundproof structure of the present invention.

FIG. 15 is a schematic front view of the soundproof structure shown in FIG. 14.

FIG. 16 is a graph showing an example of the relationship between the frequency and the absorbance in the soundproof structure of the present invention.

FIG. 17 is a graph showing another example of the relationship between the frequency and the absorbance in the soundproof structure of the present invention.

FIG. 18 is a graph showing an example of the relationship between a distance between the inner wall surface of an opening portion and the film surface of a soundproof cell and an absorption peak frequency indicating the maximum absorbance in the soundproof structure of the present invention.

FIG. 19 is a graph showing an example of the relationship between a distance between the inner wall surface of an opening portion and the film surface of a soundproof cell and the maximum absorbance in the soundproof structure of the present invention.

FIG. 20 is a graph showing another example of the relationship between the frequency and the absorbance in the soundproof structure of the present invention.

FIG. 21 is a graph showing another example of the relationship between the absorption peak frequency indicating the maximum absorbance and the maximum absorbance in the soundproof structure of the present invention.

FIG. 22 is a graph showing an example of the relationship between the frequency and the transmittance in the soundproof structure of the present invention.

FIG. 23 is a graph showing another example of the relationship between the frequency and the absorbance in the soundproof structure of the present invention.

### DESCRIPTION OF THE PREFERRED EMBODIMENTS

Hereinafter, a soundproof structure according to one embodiment of the present invention will be described in detail with reference to preferred embodiments shown in the accompanying diagrams.

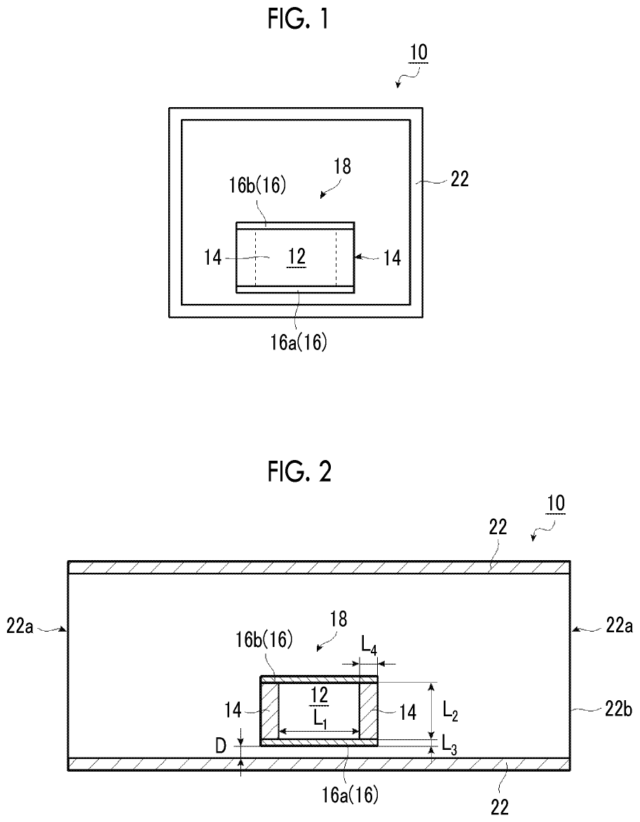

FIG. 1 illustrates a soundproof structure according to the embodiment of the present invention, and is a conceptual front view schematically showing the front seen from a sound source side. FIG. 2 is a conceptual side sectional view of the soundproof structure shown in FIG. 1.

A soundproof structure 10 of the present embodiment shown in FIG. 1 has: a soundproof cell 18 that has a frame 14 having a hole portion 12 penetrating therethrough and a vibratable film 16 (16a and 16b) fixed to the frame 14 so as to cover both opposite surfaces of the hole portion 12; and a tubular body 22 which forms an opening portion according to the embodiment of the present invention and in which the soundproof cell 18 is disposed.

The soundproof structure 10 has a structure in which the soundproof cell 18 is disposed in the tubular body 22 (opening 22a of the tubular body 22) in a state in which a surface of the film 16 (hereinafter, also referred to as a film surface) is inclined at a predetermined angle (90° in the example shown in FIG. 1) with respect to an opening cross section 22b of the tubular body 22 so that a region serving as a ventilation portion, through which gas passes, is provided in the opening 22a in the tubular body 22.

In the soundproof structure 10, a surface (film surface) of the film 16a on the wall surface side of the inner peripheral wall of the tubular body 22 of both the films 16 (16a and 16b) of the soundproof cell 18 has a portion separated from the wall surface of the tubular body 22. In the example shown in FIGS. 1 and 2, all the film surfaces of the film 16a are completely separated from the wall surface of the tubular body 22. The films 16a and 16b will be collectively described as the film 16 unless the films 16a and 16b need to be distinguished from each other for description.

Here, the tubular body 22 is a member that forms an opening portion formed in a region of an object that blocks the passage of gas. The tube wall of the tubular body 22 forms a wall of an object that blocks the passage of gas, for example, a wall of an object separating two spaces from each other. The inside of the tubular body 22 forms the opening 22a formed in a region of a part of the object that blocks the passage of gas.

In the present invention, it is preferable that the opening portion has an opening formed in the region of the object that blocks the passage of gas, and it is preferable that the opening member is provided in a wall separating two spaces from each other.

Here, the object that has a region where an opening is formed and that blocks the passage of gas refers to a member, a wall, and the like separating two spaces from each other. The member refers to a member, such as a tubular body or a cylindrical body. The wall and the like refer to, for example, a fixed wall forming a building structure such as a house, a building, and a factory, a fixed wall such as a fixed partition disposed in a room of a building to partition the inside of the room, or a movable wall such as a movable partition disposed in a room of a building to partition the inside of the room.

The opening portion according to the embodiment of the present invention may be a tubular body or a cylindrical body, such as a duct, or may be a wall itself having an opening for attaching a ventilation hole, such as a louver or a gully, or a window, or may be a mounting frame, such as a window frame attached to a wall.

The shape of the opening of the opening portion according to the embodiment of the present invention is a cross-sectional shape of a square in the illustrated example. In the present invention, however, the shape of the opening of the opening portion is not particularly limited as long as one or more soundproof cells can be disposed in the opening. For example, the shape of the opening may be other quadrangles such as a rectangle, a diamond, and a parallelogram, a triangle such as an equilateral triangle, an isosceles triangle, or a right triangle, a polygon including a regular polygon such as a regular pentagon or a regular hexagon, a circle, an ellipse, and the like, or may be an irregular shape.

Materials of a member forming the opening portion according to the embodiment of the present invention, a wall, and the like are not particularly limited. As these materials, metal materials such as aluminum, titanium, magnesium, tungsten, iron, steel, chromium, chromium molybdenum, nichrome molybdenum, and alloys thereof, resin materials such as acrylic resins, polymethyl methacrylate, polycarbonate, polyamideide, polyarylate, polyether imide, polyacetal, polyether ether ketone, polyphenylene sulfide, polysulfone, polyethylene terephthalate, polybutylene terephthalate, polyimide, and triacetyl cellulose, carbon fiber reinforced plastics (CFRP), carbon fiber, glass fiber reinforced plastics (GFRP), and wall materials such as concrete similar to the wall material of buildings and mortar can be mentioned.

The frame 14 of the soundproof cell 18 is formed by a portion surrounding the hole portion 12.

Since the frame 14 is formed so as to annularly surround the hole portion 12 penetrating therethrough and fixes and supports the film 16 (16a and 16b) so as to cover both surfaces of the hole portion 12, the frame 14 serves as a node of film vibration of the film 16 fixed to the frame 14. Therefore, the frame 14 has higher stiffness than the film 16. Specifically, it is preferable that both the mass and the stiffness of the frame 14 per unit area are high.

It is preferable that the frame 14 has a closed continuous shape capable of fixing the film 16 so as to restrain the entire periphery of the film 16. However, the present invention is not limited thereto, and the frame 14 may be made to have a discontinuous shape by cutting a part thereof as long as the frame 14 serves as a node of film vibration of the film 16 fixed to the frame 14. That is, since the role of the frame 14 is to fix and support the film 16 to control the film vibration, the effect is achieved even though there are small cuts in the frame 14 or even though there are unbonded parts.

The shape of the hole portion 12 of the frame 14 is a planar shape, and is a square in the illustrated example. In the present invention, however, the shape of the hole portion 12 of the frame 14 is not particularly limited. For example, the shape of the hole portion 12 may be other quadrangles such as a rectangle, a diamond, and a parallelogram, a triangle such as an equilateral triangle, an isosceles triangle, or a right triangle, a polygon including a regular polygon such as a regular pentagon or a regular hexagon, a circle, an ellipse, and the like, or may be an irregular shape. End portions on both sides of the hole portion 12 of the frame 14 are not blocked but opened to the outside as they are. The film 16 (16a and 16b) is fixed to both sides of the frame 14 so as to cover both the opened end portions of the hole portion 12. In the example shown in FIGS. 1 and 2, the films 16a and 16b cover both end portions of the hole portion 12. However, the present invention is not limited thereto, and the film 16 may be fixed to one side of the frame 14 so as to cover only one end portion of the hole portion 12. That is, in the present invention, the film 16 is fixed to the frame 14 so as to cover at least one end portion of the hole portion 12.

Although the end portions on both sides of the hole portion 12 of the frame 14 are not blocked but opened to the outside as they are in FIGS. 1 and 2, only one end portion of the hole portion 12 may be opened to the outside and the other end portion may be blocked by, for example, a plate member or a plate-shaped body integrated with the frame 14. In this case, the film 16 covering the hole portion 12 is fixed only to the opened one end portion of the hole portion 12.

Since the size of the frame 14 is a size in a plan view and can be defined as a size L₁ of the hole portion 12, the size of the frame 14 is assumed to be the size L₁ of the hole portion 12 hereinafter. In a case where the shape of the hole portion 12 is a circle, the size L₁ of the hole portion 12 can be defined as the diameter of the circle. In the case of a regular polygon such as a square, the size L₁ of the hole portion 12 can be defined as a distance between opposite sides passing through the center or as a circle equivalent diameter. In the case of a polygon, an ellipse, or an irregular shape, the size L₁ of the hole portion 12 can be defined as a circle equivalent diameter. In the present invention, the circle equivalent diameter and the radius are a diameter and a radius at the time of conversion into circles having the same area.

The size L₁ of the hole portion 12 of the frame 14 is not particularly limited, and may be set according to a soundproofing target to which the opening portion of the soundproof structure 10 according to the embodiment of the present invention is applied for soundproofing. The size of the hole portion 12 may be set according to, for example, a copying machine, a blower, air conditioning equipment, a ventilator, a pump, a generator, a duct, industrial equipment including various kinds of manufacturing equipment capable of emitting sound such as a coating machine, a rotary machine, and a conveyor machine, transportation equipment such as an automobile, a train, and aircraft, and general household equipment such as a refrigerator, a washing machine, a dryer, a television, a copying machine, a microwave oven, a game machine, an air conditioner, a fan, a personal computer (PC), a vacuum cleaner, and an air purifier.

The soundproof structure 10 itself can be used like a partition in order to shield sound from a plurality of noise sources. Also in this case, the size L₁ of the frame 14 can be selected from the frequency of the target noise.

It is preferable that the soundproof cell 18 configured to include the frame 14 and the film 16 is smaller than the wavelength of the first natural vibration frequency of the film 16. For this reason, in order to make the soundproof cell 18 smaller than the wavelength of the first natural vibration frequency, it is preferable to reduce the size L₁ of the frame 14.

For example, although the size L₁ of the hole portion 12 is not particularly limited, the size L₁ of the hole portion 12 is preferably 0.5 mm to 300 mm, more preferably 1 mm to 100 mm, and most preferably 10 mm to 50 mm.

The width L₄ and the thickness L₂ of the frame 14 are not particularly limited as long as the film 16 can be fixed so that the film 16 can be reliably supported. For example, the width L₄ and the thickness L₂ of the frame 14 can be set according to the size L₁ of the hole portion 12.

For example, in a case where the size L₁ of the hole portion 12 is 0.5 mm to 50 mm, the width L₄ of the frame 14 is preferably 0.5 mm to 20 mm, more preferably 0.7 mm to 10 mm, and most preferably 1 mm to 5 mm.

In a case where the size L₁ of the hole portion 12 exceeds 50 mm and is equal to or less than 300 mm, the width L₄ of the frame 14 is preferably 1 mm to 100 mm, more preferably 3 mm to 50 mm, and most preferably 5 mm to 20 mm.

In a case where the ratio of the width L₄ of the frame 14 to the size L₁ of the frame 14 is too large, the area ratio of the frame 14 with respect to the entire structure increases. Accordingly, there is a concern that the device (soundproof structure 18) will become heavy. On the other hand, in a case where the ratio is too small, it is difficult to strongly fix the film 16 with an adhesive or the like in the frame 14 portion.

In addition, the thickness L₂ of the frame 14, that is, the thickness L₂ of the hole portion 12 is preferably 0.5 mm to 200 mm, more preferably 0.7 mm to 100 mm, and most preferably 1 mm to 50 mm.

Since it is preferable to make the soundproof cell 18 smaller than the wavelength of the first natural vibration frequency of the film 16, it is preferable that the size L₁ of the frame 14 (hole portion 12) is a size equal to or less than the wavelength of the first natural vibration frequency of the film 16 fixed to the soundproof cell 18.

In a case where the size L₁ of the frame 14 (hole portion 12) of the soundproof cell 18 is a size equal to or less than the wavelength of the first natural vibration frequency of the film 16, sound pressure with low strength unevenness is applied to the film surface of the film 16. Therefore, a vibration mode of a film in which it is difficult to control sound is hard to be induced. That is, the soundproof cell 18 can acquire high sound controllability.

In order to apply a sound pressure with less strength unevenness to the film surface of the film 16, (that is, in order to make the sound pressure applied to the film surface of the film 16 more uniform), assuming that the wavelength of the first natural vibration frequency of the film 16 fixed to the soundproof cell 18 is λ, the size L₁ of the frame 14 (hole portion 12) is preferably λ/2 or less, more preferably λ/4 or less, and most preferably λ/8 or less.

The material of the frame 14 is not particularly limited as long as the material can support the film 16, has a suitable strength in the case of being applied to the above soundproofing target, and is resistant to the soundproof environment of the soundproofing target, and can be selected according to the soundproofing target and the soundproof environment. For example, as materials of the frame 14, metal materials such as aluminum, titanium, magnesium, tungsten, iron, steel, chromium, chromium molybdenum, nichrome molybdenum, and alloys thereof, resin materials such as acrylic resins, polymethyl methacrylate, polycarbonate, polyamideide, polyarylate, polyether imide, polyacetal, polyether ether ketone, polyphenylene sulfide, polysulfone, polyethylene terephthalate, polybutylene terephthalate, polyimide, and triacetyl cellulose, carbon fiber reinforced plastics (CFRP), carbon fiber, and glass fiber reinforced plastics (GFRP) can be mentioned.

A plurality of types of these materials may also be used in combination as materials of the frame 14.

The same material as the material of the frame 14 can also be used as a plate material used to block the end portion of one surface of the hole portion 12 of the frame 14.

In particular, in a case where one end portion of the hole portion 12 is covered by the film 16 and the other end portion is opened, a conventionally known sound absorbing material may be disposed in the hole portion 12 of the frame 14.

By arranging the sound absorbing material, the sound insulation characteristics can be further improved by the sound absorption effect of the sound absorbing material.

The sound absorbing material is not particularly limited, and various known sound absorbing materials, such as a urethane foam and a nonwoven fabric, can be used.

The soundproof structure 10 according to the embodiment of the present invention may be placed in an opening portion including the tubular body 22, such as a duct, together with various known sound absorbing materials, such as a urethane foam and a nonwoven fabric.

As described above, by using a known sound absorbing material in combination within the soundproof structure according to the embodiment of the present invention or together with the soundproof structure according to the embodiment of the present invention, both the effect of the soundproof structure according to the embodiment of the present invention and the effect of the known sound absorbing material can be obtained.

Since the film 16 is fixed so as to be restrained by the frame 14 so as to cover the hole portion 12 inside the frame 14, the film 16 vibrates in response to sound waves from the outside. By absorbing or reflecting the energy of sound waves, the sound is insulated.

Incidentally, since the film 16 needs to vibrate with the frame 14 as a node, it is necessary that the film 16 is fixed to the frame 14 so as to be reliably restrained by the frame 14 and accordingly becomes an antinode of film vibration, thereby absorbing or reflecting the energy of sound waves to insulate sound. For this reason, it is preferable that the film 16 is formed of a flexible elastic material.

Therefore, the shape of the film 16 can be said to be the shape of the hole portion 12 of the frame 14. In addition, the size of the film 16 can be said to be the size L₁ of the frame 14 (hole portion 12).

The thickness of the film 16 is not particularly limited as long as the film can vibrate by absorbing the energy of sound waves to insulate sound. However, it is preferable to make the film 16 thick in order to obtain a natural vibration mode on the high frequency side and thin in order to obtain the natural vibration mode on the low frequency side. For example, the thickness L₃ of the film 16 can be set according to the size L₁ of the hole portion 12, that is, the size L₁ of the film 16 in the present invention.

For example, in a case where the size L₁ of the hole portion 12 is 0.5 mm to 50 mm, the thickness L₃ of the film 16 is preferably 0.001 mm (1 μm) to 5 mm, more preferably 0.005 mm (5 μm) to 2 mm, and most preferably 0.01 mm (10 μm) to 1 mm.

In a case where the size L₁ of the hole portion 12 exceeds 50 mm and is equal to or less than 300 mm, the thickness L₃ of the film 16 is preferably 0.01 mm (10 μm) to 20 mm, more preferably 0.02 mm (20 μm) to 10 mm, and most preferably 0.05 mm (50 μm) to 5 mm.

It is preferable that the thickness of the film 16 is expressed by an average thickness, for example, in a case where there are different thicknesses in one film 16.

Here, the film 16 fixed to the frame 14 of the soundproof cell 18 has a first natural vibration frequency, which is the frequency of the lowest order natural vibration mode that can be induced in the structure of the soundproof cell 18.

For example, the film 16 fixed to the frame 14 of the soundproof cell 18 has a resonance frequency having a lowest absorption peak at which the transmission loss of the film is minimized with respect to the sound field incident substantially perpendicular to the film 16, which is the frequency of the lowest order natural vibration mode, that is, has the first natural vibration frequency. That is, in the present invention, at the first natural vibration frequency of the film 16, sound is transmitted and an absorption peak of the lowest order frequency is obtained. In the present invention, the resonance frequency is determined by the soundproof cell 18 configured to include the frame 14 and the film 16.

That is, the resonance frequency of the film 16, which is fixed so as to be restrained by the frame 14, in the structure configured to include the frame 14 and the film 16 is a frequency at which the sound wave most vibrates the film, and is a frequency of the natural vibration mode in which the sound wave is largely transmitted at the frequency and which has an absorption peak of the lowest order frequency.

In the present invention, the first natural vibration frequency is determined by the soundproof cell 18 configured to include the frame 14 and the film 16. In the present invention, the first natural vibration frequency determined in this manner is referred to as a first natural vibration frequency of a film.

The first natural vibration frequency (for example, a boundary between a frequency region according to the stiffness law and a frequency region according to the mass law becomes the lowest order first resonance frequency) of the film 16 fixed to the frame 14 is preferably 10 Hz to 100000 Hz corresponding to the sound wave sensing range of a human being, more preferably 20 Hz to 20000 Hz that is the audible range of sound waves of a human being, even more preferably 40 Hz to 16000 Hz, most preferably 100 Hz to 12000 Hz.

In the soundproof cell 18 of the present embodiment, the resonance frequency of the film 16 in the structure configured to include the frame 14 and the film 16, for example, the first natural vibration frequency of the film 16 can be determined by the geometric form of the frame 14 of the soundproof cell 18, for example, the shape and size of the frame 14 and the stiffness of the film 16 of the soundproof cell 18, for example, the thickness and flexibility of the film 16 and the volume of the space behind the film.

For example, as a parameter characterizing the natural vibration mode of the film 16, in the case of the film 16 of the same material, assuming that the thickness L₃ of the film 16 is t and the size L₁ of the hole portion 12 is R, a ratio [R²/t] between the thickness of the film 16 and the square of the size of the hole portion 12 can be used. Here, as the size of the hole portion 12, for example, in the case of a square, the size of the hole portion 12 can be the size L₁ of one side. In a case where this ratio [R²/t] is equal, the natural vibration mode becomes the same frequency, that is, the same resonance frequency. That is, by setting the ratio [R²/t] to a fixed value, the scale law is established. Accordingly, an appropriate size can be selected.

The Young's modulus of the film 16 is not particularly limited as long as the film 16 has elasticity capable of performing film vibration in order to insulate sound by absorbing or reflecting the energy of sound waves. It is preferable that the Young's modulus of the film 16 is large in order to obtain the natural vibration mode on the high frequency side and small in order to obtain the natural vibration mode on the low frequency side. For example, the Young's modulus of the film 16 can be set according to the size of the frame 14 (hole portion 12), that is, the size of the film in the present invention.

For example, the Young's modulus of the film 16 is preferably 1000 Pa to 3000 GPa, more preferably 10000 Pa to 2000 GPa, and most preferably 1 MPa to 1000 GPa.

The density of the film 16 is not particularly limited as long as the film 16 can vibrate by absorbing or reflecting the energy of sound waves to insulate sound. For example, the density of the film 16 is preferably 5 kg/m³ to 30000 kg/m³, more preferably 10 kg/m³ to 20000 kg/m³, and most preferably 100 kg/m³ to 10000 kg/m³.

In a case where a film-shaped material or a foil-shaped material is used as a material of the film 16, the material of the film 16 is not particularly limited as long as the material has a strength in the case of being applied to the above soundproofing target and is resistant to the soundproof environment of the soundproofing target so that the film 16 can vibrate by absorbing or reflecting the energy of sound waves to insulate sound, and can be selected according to the soundproofing target, the soundproof environment, and the like. Examples of the material of the film 16 include resin materials that can be made into a film shape such as polyethylene terephthalate (PET), polyimide, polymethylmethacrylate, polycarbonate, acrylic (PMMA), polyamideide, polyarylate, polyetherimide, polyacetal, polyetheretherketone, polyphenylene sulfide, polysulfone, polybutylene terephthalate, triacetyl cellulose, polyvinylidene chloride, low density polyethylene, high density polyethylene, aromatic polyamide, silicone resin, ethylene ethyl acrylate, vinyl acetate copolymer, polyethylene, chlorinated polyethylene, polyvinyl chloride, polymethyl pentene, and polybutene, metal materials that can be made into a foil shape such as aluminum, chromium, titanium, stainless steel, nickel, tin, niobium, tantalum, molybdenum, zirconium, gold, silver, platinum, palladium, iron, copper, and permalloy, fibrous materials such as paper and cellulose, and materials or structures capable of forming a thin structure such as a nonwoven fabric, a film containing nano-sized fiber, porous materials including thinly processed urethane or synthrate, and carbon materials processed into a thin film structure.

In addition, the film 16 is fixed to the frame 14 so as to cover an opening on at least one side of the hole portion 12 of the frame 14. That is, the film 16 may be fixed to the frame 14 so as to cover openings on one side, the other side, or both sides of the hole portion 12 of the frame 14.

The method of fixing the film 16 to the frame 14 is not particularly limited. Any method may be used as long as the film 16 can be fixed to the frame 14 so as to serve as a node of film vibration. For example, a method using an adhesive, a method using a physical fixture, and the like can be mentioned.

In the method of using an adhesive, an adhesive is applied onto the surface of the frame 14 surrounding the hole portion 12 and the film 16 is placed thereon, so that the film 16 is fixed to the frame 14 with the adhesive. Examples of the adhesive include epoxy-based adhesives (Araldite (registered trademark) (manufactured by Nichiban Co., Ltd.) and the like), cyanoacrylate-based adhesives (Aron Alpha (registered trademark) (manufactured by Toagosei Co., Ltd.) and the like), and acrylic-based adhesives.

As a method using a physical fixture, a method can be mentioned in which the film 16 disposed so as to cover the hole portion 12 of the frame 14 is interposed between the frame 14 and a fixing member, such as a rod, and the fixing member is fixed to the frame 14 by using a fixture, such as a screw.

Although the soundproof cell 18 of the first embodiment has a structure in which the frame 14 and the film 16 are formed as separate bodies and the film 16 is fixed to the frame 14, the present invention is not limited thereto, and a structure in which the film 16 and the frame 14 formed of the same material are integrated may be adopted.

The soundproof cell 18 of the present embodiment is formed as described above.

The opening ratio indicating the air permeability or the ventilation property of the ventilation portion provided in the opening portion of the soundproof structure according to the embodiment of the present invention is defined by the following Equation (1).

Opening ratio (%)={1−(cross-sectional area of soundproof cell in opening cross section/cross-sectional area of opening)}×100 (1)

Here, from the viewpoint of air permeability, the opening ratio of the soundproof structure 10 shown in FIGS. 1 and 2 is preferably 10% or more, more preferably 25% or more, and even more preferably 50% or more.

From the viewpoint of air permeability, the inclination angle θ of the film surface of the film 16 with respect to the opening cross section 22b of the tubular body 22 is preferably 20° or more, more preferably 45° or more, and even more preferably 80° or more.

The soundproof cell 18 is disposed at a position of high sound pressure, which is formed on the tubular body 22 by the sound wave of the first natural vibration frequency of the soundproof cell 18, in the tubular body 22 that is an opening portion. Specifically, the soundproof cell 18 is preferably disposed within ±λ/4 from the position of the antinode of the sound pressure distribution of the standing wave formed on the tubular body 22 by the sound wave of the first natural vibration frequency of the soundproof cell 18, more preferably disposed within ±λ/6 from the position of the antinode of the sound pressure distribution of the standing wave, even more preferably disposed within ±λ/8 from the position of the antinode of the sound pressure distribution of the standing wave, and most preferably disposed at the position of the antinode of the sound pressure distribution of the standing wave.

For example, in a case where the tubular body 22 is a cylinder or a duct in which an object, such as a wall or a cover, is disposed at its open end, that is, in a case where the object is a fixed end of the sound wave, the soundproof cell 18 is preferably disposed within λ/4 of the sound wave of the first natural vibration frequency of the soundproof cell 18 from the object, more preferably disposed within λ/6 of the sound wave of the first natural vibration frequency of the soundproof cell 18 from the object, and even more preferably disposed within λ/8 of the sound wave of the first natural vibration frequency of the soundproof cell 18 from the object.

On the other hand, in a case where the tubular body 22 is a cylinder or a duct in which there is no object, such as a wall or a cover, disposed at its open end, that is, in a case where the open end of the tubular body is the free end of the sound wave, the soundproof cell 18 is preferably disposed within λ/4 of the sound wave of the first natural vibration frequency of the soundproof cell 18—opening end correction distance of ±λ/4 from the open end, more preferably disposed within λ/4—opening end correction distance of ±λ/6 from the opening end, and even more preferably disposed within λ/4—opening end correction distance of ±λ/8 from the opening end. The opening end correction refers to a phenomenon in which the antinode of the opening end standing wave slightly protrudes in a case where the sound resonates in the air column. For this reason, the antinode of the standing wave of the sound field protrudes outside the opening 22a of the tubular body 22 by the opening end correction distance. Therefore, the soundproofing performance can be obtained even outside the tubular body 22. In the case of the cylindrical tubular body 22, the opening end correction distance is approximately 0.61×tube radius, and increases as the diameter increases.

As described above, in the soundproof structure according to the embodiment of the present invention, the surface of the film on the side of the wall surface of the opening portion in at least one film of the soundproof cell needs to have a portion away from the wall surface.

In the example shown in FIGS. 1 and 2, all the film surfaces of the film 16a of the soundproof cell 18 are completely separated from the wall surface of the tubular body 22. However, in the present invention, a part of the film surface of the film 16a may be in contact with the wall surface of the inner peripheral wall of the tubular body 22. For example, in a case where the film surface of the film 16a is inclined with respect to the wall surface of the tubular body 22, one end portion of the film surface may be in contact with the wall surface. As will be described later, in a case where the soundproof cell 18 is disposed so as to straddle a corner portion of the tubular body 22 having a polygonal opening such as a square, both end portions of the film surface of the film 16a of the soundproof cell 18 may be in contact with two wall surfaces of the tubular body 22 perpendicular to each other. In a case where the soundproof cell 18 is disposed along the inner peripheral wall of the opening portion having a circular opening, both end portions of the film surface of the film 16a of the soundproof cell 18 may be in contact with the circular wall surface of the tubular body 22.

In any case, a space is present between the surface of the film on the side of the wall surface of the opening portion and the wall surface, and the space needs to communicate with the ventilation portion.

As described above, since the surface (film surface) of the film 16a and the wall surface of the inner peripheral wall of the tubular body 22 forming the opening portion are separated from each other, a space is present between the film surface and the wall surface. Therefore, a distance D between the film surface and the wall surface (refer to FIG. 2) can be defined. Here, the distance D between the film surface of the film 16a and the wall surface of the tubular body 22 needs to be 0.1 mm or more, preferably 1 mm or more, and preferably 20 mm or less.

In addition, it is preferable that the distance between the film surface of the film 16a and the wall surface of the tubular body 22 (hereinafter, also referred to as a separation distance or an inter-plane distance) D is adjustable. In a case where the film surface of the film 16a is inclined with respect to the wall surface of the tubular body 22, an angle between the surface of the film 16a and the wall surface of the tubular body 22 is preferably adjustable.

In the present invention, in a case where the separation distance D between the film surface of the film 16a and the wall surface of the tubular body 22 is not fixed as in a case where the film surface of the film 16a is inclined with respect to the wall surface of the tubular body 22, an average value may be calculated for the film surface of the film 16a, and the calculated average value may be defined as the distance D between the film surface and the wall surface.

As will be described later, in the present invention, as the distance D between the surface of the film of the soundproof cell and the wall surface of the opening portion decreases, the absorption peak frequency at the spectral peak of soundproofing of the soundproof cell decreases. For this reason, the distance D between the film surface of the film 16a and the wall surface of the tubular body 22 needs to be a distance set according to the absorption peak frequency.

In the present invention, in order to maintain the inter-plane distance D between the surface of the film 16a of the soundproof cell 18 and the wall surface of the tubular body 22 forming the opening portion at a distance set according to the absorption peak frequency, it is necessary to dispose the soundproof cell 18 at a predetermined position in the tubular body 22 by a holding member (not shown).

Here, the holding member is not particularly limited as long as the soundproof cell 18 can be disposed at a predetermined position in the tubular body 22. As a holding member, for example, a spacer, a suspension bracket, a post, a pin, a bolt, and the like can be mentioned. In the soundproof structure 10 shown in FIGS. 1 and 2, a thin linear or rod-like member having no acoustic influence, for example, a spacer, a suspension bracket, a post, a pin, a threaded rod, or the like having no acoustic influence can also be used as a holding member.

The soundproof structure 10 according to the embodiment of the present invention is basically formed as described above.

Hereinafter, a specific embodiment in the case of using a spacer as holding means will be described.

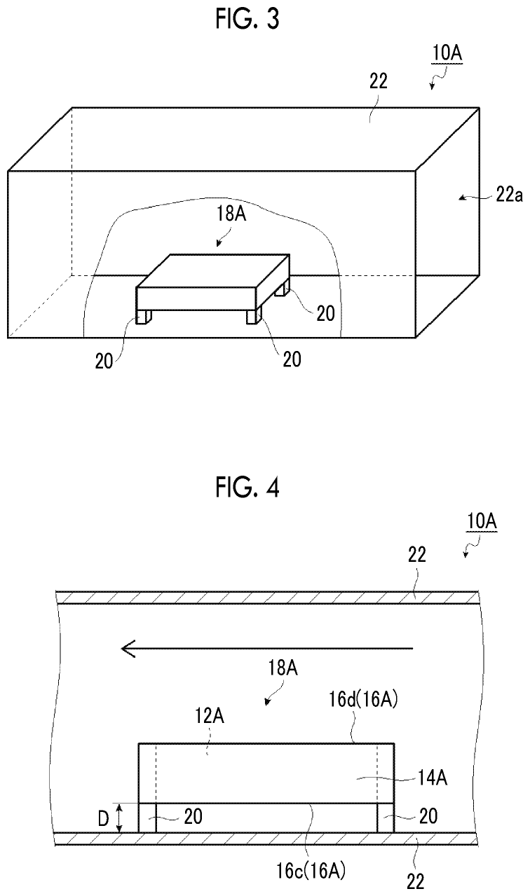

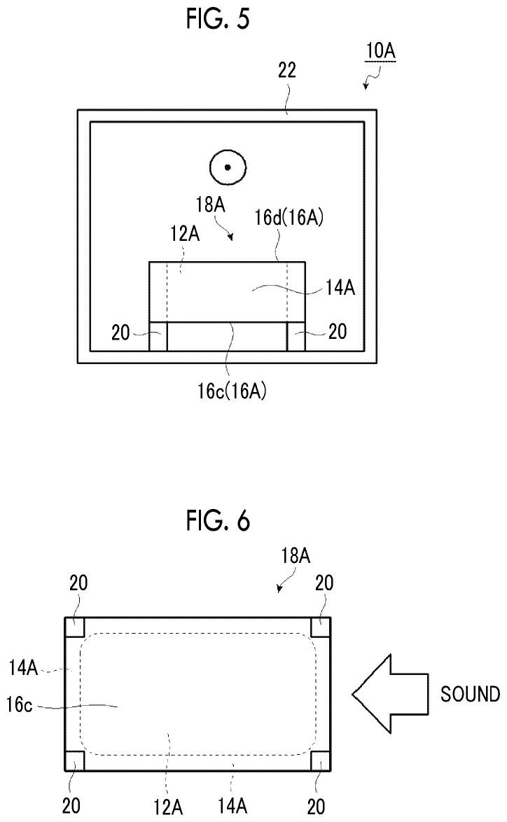

FIG. 3 is a partially broken perspective view schematically showing an example of a soundproof structure according to an embodiment of the present invention. FIG. 4 is a schematic partial side cross-sectional view showing the arrangement state of a soundproof cell in an opening portion of the soundproof structure shown in FIG. 3. FIG. 5 is a schematic front view of the soundproof structure shown in FIG. 3. FIG. 6 is a bottom view of the soundproof cell of the soundproof structure shown in FIG. 3 as viewed from the spacer side.

A soundproof structure 10A shown in FIGS. 3 to 6 has a rectangular parallelepiped soundproof cell 18A that has a frame 14A having a hole portion 12A with a rectangular shape in a plan view and a film 16A (16c and 16d) fixed to the frame 14A so as to cover both surfaces of the hole portion 12A, the tubular body 22 in which the soundproof cell 18A is disposed, and four columnar spacers 20 for arranging the film 16c of the soundproof cell 18A inside the tubular body 22 so as to be spaced apart from the wall surface of the inner peripheral wall of the tubular body 22 by a predetermined distance.

The soundproof structure 10A shown in FIGS. 3 to 6 has the same configuration as the soundproof structure 10 shown in FIGS. 1 and 2 except that the shapes of the hole portion 12A, the frame 14A, and the film 16A (16c and 16d) in a plan view are rectangles but the shapes of the hole portion 12, the frame 14, and the film 16 (16a and 16b) in a plan view are squares and the four spacers 20 are provided. Therefore, detailed description of similar components and the same components having the same reference numerals will be omitted, and the differences will mainly be described.

The soundproof cell 18A is fixed to the wall surface of the tubular body 22 through the four spacers 20 so that the longitudinal direction of the rectangular parallelepiped shape and the longitudinal direction of the tubular body 22 are the same. As shown in FIGS. 3 to 6, the four spacers 20 are attached to four corners of the film 16c of the soundproof cell 18A on the wall surface side of the tubular body 22.

In the four spacers 20, a gap between the two spacers 20 adjacent to each other communicates with a ventilation portion in the tubular body 22 through which sound propagates. For this reason, sound enters the gap between the spacers 20.

Incidentally, in a case where the sound enters from the opening 22a on the right side of FIG. 3 and propagates from the right to the left as indicated by the arrow in FIG. 4, the sound is absorbed by film vibration of the film 16A (16c and 16d) of the soundproof cell 18A and exits through the opening 22a on the left side of FIG. 3. In addition, FIG. 5 indicates that the sound travels from the back side to the front side, as can be seen from the mark shown in the diagram.

In the soundproof structure 10A, the sound propagating through the tubular body 22 enters as it is a gap between the four spacers 20 and a gap on the upstream side facing or perpendicular to the incidence direction or the traveling direction (hereinafter, represented by the traveling direction) of the sound, and the sound propagating through the tubular body 22 wraps around into two gaps along the traveling direction of the sound or parallel to the traveling direction of the sound, thereby vibrating the film 16c. Thus, in a case where the sound propagates through the tubular body 22, the sound enters from three gaps between the four spacers 20, is absorbed by the film vibration of the film 16c, exits from the gap on the downstream side facing the traveling direction of the sound, and further exits from the two gaps along the traveling direction of the sound.

The spacer 20 shown in FIGS. 3 to 6 is a columnar body having a square cross section. The length or height of the spacer 20 determines the inter-plane distance D (for example, refer to FIG. 4) between the wall surface of the tubular body 22 and the film surface of the film 16c of the soundproof cell 18A. The cross-sectional size of the spacer 20 is preferably set to the same size as the width of the frame 14A as the size of one side, but may be smaller than the width of the frame 14A as long as the soundproof cell 18A can be fixed to the wall surface of the tubular body 22. Although the sizes of the four spacers 20 shown in FIGS. 3 to 6 are the same, different sizes may be included as long as the soundproof cell 18A can be fixed to the wall surface of the tubular body 22.

The material of the spacer 20 is not particularly limited as long as the spacer 20 can fix the soundproof cell 18A to the wall surface of the tubular body 22, but the same material as the material of the frame 14 of the soundproof structure 10 described above can be used.

The method of attaching the spacer 20 to the film 16c is not particularly limited as long as it is possible to reliably attach the spacer 20 to the film 16c, but it is preferable to use a method similar to the method of fixing the film 16 to the frame 14 of the soundproof structure 10 described above. By firmly fixing the spacer 20 to the film 16c in this manner, the spacer 20 and the soundproof cell 18A can be formed as an integrated structure. In addition, as a method of attaching the spacer 20 to the film 16c, a method using a double-sided tape or the like may be used.

Alternatively, one end of the spacer 20 is attached or fixed to the film 16c of the soundproof cell 18A. On the other hand, the other end of the spacer 20 may be attached to or placed and fixed to a predetermined position of the wall surface (that is, the bottom wall surface) of the tubular body 22. However, the other end of the spacer 20 may be firmly fixed to the bottom wall surface of the tubular body 22 in the same manner as the method of fixing the film 16 to the frame 14 of the soundproof structure 10 described above.

Although the four spacers 20 of the soundproof structure 10A shown in FIGS. 3 to 6 are columnar bodies, the present invention is not limited thereto, and the four spacers 20 of the soundproof structure 10A shown in FIGS. 3 to 6 may be plate-shaped bodies and the like.

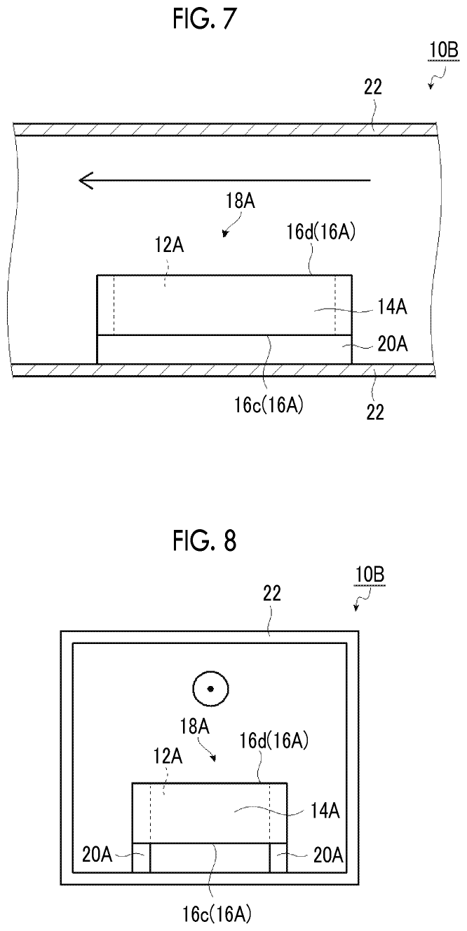

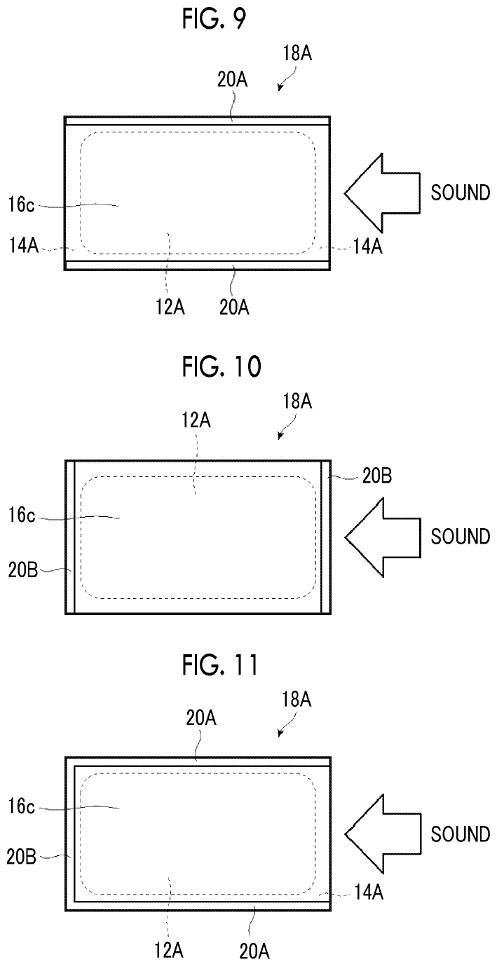

FIG. 7 is a schematic partial side cross-sectional view showing the arrangement state of a soundproof cell in an opening portion in another example of the soundproof structure according to the embodiment of the present invention. FIG. 8 is a schematic front view of the soundproof structure shown in FIG. 7. FIG. 9 is a bottom view of the soundproof cell of the soundproof structure shown in FIG. 7 as viewed from the spacer side.

A soundproof structure 10B shown in FIGS. 7 to 9 has a rectangular parallelepiped soundproof cell 18A that has a frame 14A having a hole portion 12A with a rectangular shape in a plan view and a film 16A (16c and 16d) fixed to the frame 14A so as to cover both surfaces of the hole portion 12A, the tubular body 22 in which the soundproof cell 18A is disposed, and two plate-shaped spacers 20A for arranging the film 16c of the soundproof cell 18A inside the tubular body 22 so as to be spaced apart from the wall surface of the inner peripheral wall of the tubular body 22 by a predetermined distance.

The soundproof structure 10B shown in FIGS. 7 to 9 has the same configuration as the soundproof structure 10A shown in FIGS. 3 to 6 except that the two plate-shaped spacers 20A are provided instead of the four columnar spacers 20. Therefore, detailed description of similar components and the same components having the same reference numerals will be omitted, and the differences will mainly be described.

The soundproof cell 18A is fixed to the wall surface of the tubular body 22 through the two plate-shaped spacers 20A extending in the longitudinal direction so that the longitudinal direction of the rectangular parallelepiped shape and the longitudinal direction of the tubular body 22 are the same. As shown in FIGS. 7 to 9, the two spacers 20A are attached along the longitudinal direction at positions corresponding to the frame 14A on both sides of the film 16c of the soundproof cell 18A on the wall surface side of the tubular body 22.

Incidentally, in a case where the sound enters from an opening on the right side (not shown) of the tubular body 22 and propagates from the right to the left as indicated by the arrow in FIG. 7, the sound is absorbed by film vibration of the film 16A (16c and 16d) of the soundproof cell 18A and exits through an opening on the left side (not shown). In addition, as in FIG. 5, FIG. 8 indicates that the sound travels from the back side to the front side.

In the two spacers 20A, a gap between the two spacers 20A communicates with a ventilation portion in the tubular body 22 through which sound propagates, and the sound enters the gap.

That is, in the soundproof structure 10B, the gaps between the two spacers 20A are two gaps facing each other in the sound traveling direction indicated by the arrow in FIGS. 7 and 9, and the sound propagating through the tubular body 22 enters as it is a gap on the upstream side facing the traveling direction of the sound, thereby vibrating the film 16c. Thus, in a case where the sound propagates through the tubular body 22, the sound enters from the gap on the upstream side, is absorbed by the film vibration of the film 16c, and exits from the gap on the downstream side.

The spacer 20A shown in FIGS. 7 to 9 is a thin rectangular parallelepiped plate-shaped body. The height of the spacer 20A determines the distance D between the bottom wall surface of the tubular body 22 and the film 16c of the soundproof cell 18B. The length of the spacer 20A in the longitudinal direction is preferably set to the same length as the length of the frame 14A in the longitudinal direction, but may be shorter than the length of the frame 14A as long as the soundproof cell 18A can be fixed to the wall surface of the tubular body 22. The plate thickness of the spacer 20A is preferably the same as the width of the frame 14A, but may be smaller than the width of the frame 14A as long as the soundproof cell 18A can be fixed to the wall surface of the tubular body 22. In addition, the sizes of the two spacers 20A may be different as long as the soundproof cell 18A can be fixed to the wall surface of the tubular body 22.

As a material of the spacer 20A, the same material as the above-described material of the spacer 20 can be used.

As a method of attaching the spacer 20A to the film 16c and a method of attaching the spacer 20A to the wall surface (that is, the bottom wall surface) of the tubular body 22, it is possible to use the same method as the above-described method of attaching the spacer 20 to the film 16c.

In the soundproof structure 10B shown in FIGS. 7 to 9, the two plate-shaped spacers 20A are attached to positions corresponding to the frame 14A on both sides along the longitudinal direction of the film 16c of the soundproof cell 18A, and are disposed along the traveling direction of the sound indicated by the arrows. However, as shown in FIG. 10, two plate-shaped spacers 20B attached to the positions corresponding to the frame 14A on both sides along the longitudinal direction of the film 16c of the soundproof cell 18A may be disposed along a direction facing the traveling direction of the sound indicated by the arrow.

Since the spacer 20B shown in FIG. 10 has the same configuration as the spacer 20A shown in FIGS. 7 to 9 except that the lengths are different, detailed description thereof will be omitted.

The gaps between the two spacers 20B are two gaps on both sides along the traveling direction of the sound indicated by the arrow, and communicate with a ventilation portion in the tubular body 22 through which sound propagates, and the sound enters the gaps on both sides. That is, the sound propagating through the tubular body 22 wraps around into two gaps between the two spacers 20B, thereby vibrating the film 16c. Thus, in a case where the sound propagates through the tubular body 22, the sound enters from the gaps on both sides, for example, from the upstream side, is absorbed by the film vibration of the film 16c, and exits from the downstream sides of the gaps on both sides.

As shown in FIG. 11, the two spacers 20A shown in FIG. 9 may be used, and one spacer 20B on the downstream side in the traveling direction of the sound shown in FIG. 10 may be used.

In this case, since there is only one gap on the upstream side between the two spacers 20A, sound enters from this one gap, is absorbed by the film vibration of the film 16c, and exits from the same gap again.

Alternatively, as shown in FIG. 12, the two spacers 20A may be used, and contrary to FIG. 11, one spacer 20B on the upstream side in the traveling direction of the sound may be used.

In this case, since there is only one gap on the downstream side between the two spacers 20A, sound enters from this one gap, is absorbed by the film vibration of the film 16c, and exits from the same gap again.

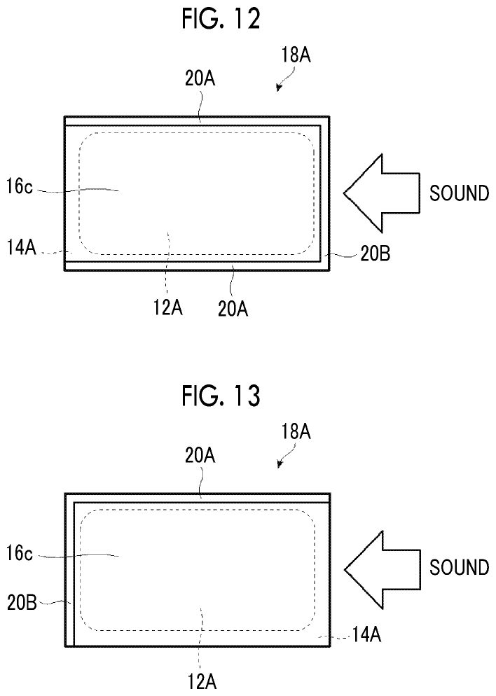

Alternatively, as shown in FIG. 13, one spacer 20A shown in FIG. 9 may be used, and one spacer 20B on the downstream side in the traveling direction of the sound shown in FIG. 10 may be used.

In this case, the gaps between the spacers 20A and 20B are a gap on the upstream side facing the traveling direction of the sound and a gap along the traveling direction of the sound, but both the gaps are connected to each other. Therefore, the sound enters mainly from the gap on the upstream side and the upstream side of the gap along the traveling direction of the sound, is absorbed by the film vibration of the film 16c, and exits from the upstream side of the gap along the traveling direction of the sound.

As shown in FIG. 13, in the case of using one spacer 20A and one spacer 20B, the spacer 20A may be provided on any side, and the spacer 20B may be provided on any side of the upstream side and the downstream side in the traveling direction of the sound.

In the examples described above, by using at least one of the spacer 20, the spacer 20A, or the spacer 20B, the distance between the wall surface of the tubular body 22 and the film surface (surface) of the film 16c on the wall surface side of the soundproof cell 18A and the angle between the wall surface of the tubular body 22 and the film surface of the film 16c are fixed. However, the present invention is not limited thereto, and it is preferable that the distance between the wall surface of the tubular body 22 and the film surface of the film 16c and the angle between the wall surface of the tubular body 22 and the film surface of the film 16c are adjustable.

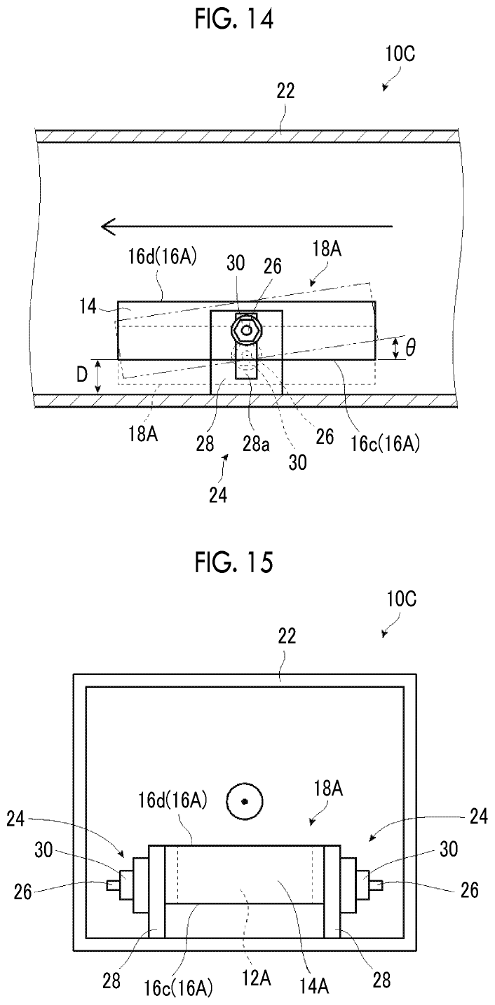

FIG. 14 is a schematic partial side cross-sectional view showing the arrangement state of a soundproof cell in an opening portion in another example of the soundproof structure according to the embodiment of the present invention. FIG. 15 is a schematic front view of the soundproof structure shown in FIG. 14.

A soundproof structure 10C shown in FIGS. 14 to 15 has a rectangular parallelepiped soundproof cell 18A that has a frame 14A having a hole portion 12A and a film 16A (16c and 16d) fixed to the frame 14A so as to cover both surfaces of the hole portion 12A, the tubular body 22 in which the soundproof cell 18A is disposed, and a distance adjusting mechanism 24 for arranging the film 16c of the soundproof cell 18A inside the tubular body 22 so as to be spaced apart from the wall surface of the inner peripheral wall of the tubular body 22 by a predetermined adjustable distance.

The soundproof structure 10C shown in FIGS. 14 and 15 has the same configuration as the soundproof structure 10B shown in FIGS. 7 to 9 except that the distance adjusting mechanism 24 is provided instead of the two plate-shaped spacers 20A. Therefore, the same components are denoted by the same reference numerals, and the detailed description thereof will be omitted, and the differences will mainly be described.

The distance adjusting mechanism 24 has two screws 26 attached to both side surfaces of the frame 14A of the soundproof cell 18A in the longitudinal direction, two side plates 28 each having a long hole 28a through which the screw 26 is inserted, and two round seat hexagonal nuts 30 screwed into the two screws 26 attached to the soundproof cell 18A.

The two side plates 28 are used to interpose and support both side surfaces of the soundproof cell 18A in the longitudinal direction, and are fixed to the bottom wall surface of the tubular body 22.

The two screws 26 of the soundproof cell 18A are inserted through the long holes 28a of the side plates 28 and protrude from the side plates 28.

By screwing the nuts 30 to the two screws 26 protruding from the two side plates 28 so that the two nuts 30 and the side plates 28 are brought into contact with each other and tightened, both the side surfaces of the frame 14A of the soundproof cell 18A and the two side plates 28 can be fixed to each other so as to be in close contact with each other.

In this manner, the distance D between the wall surface of the tubular body 22 and the film surface of the film 16c (refer to FIG. 14) can be maintained at a predetermined distance.

For example, in a case where the soundproof cell 18A is at a position shown by the dotted line in FIG. 14, the distance D between the wall surface of the tubular body 22 and the film surface of the film 16c can be adjusted by moving the soundproof cell 18A to a position shown by the solid line in FIG. 14 as follows.

In the case of adjusting the distance D between the wall surface of the tubular body 22 and the film surface of the film 16c, the nut 30 is loosened to release the close contact between the side surface of the frame 14A of the soundproof cell 18A and the side plate 28. Thereafter, the soundproof cell 18A is moved relative to the wall surface of the tubular body 22. At this time, the film surface of the soundproof cell 18A and the wall surface of the tubular body 22 are parallel to each other. For example, the soundproof cell 18A is moved from the position shown by the dotted line to the position shown by the solid line. As a result, the screw 26 of the soundproof cell 18A is moved in the long hole 28a of the side plate 28.

In this manner, the distance D between the wall surface of the tubular body 22 and the film surface of the film 16c is adjusted.

Thereafter, by screwing the nut 30 to the screw 26 again so that the nut 30 and the side plate 28 are brought into contact with each other and tightened, both the side surfaces of the frame 14A of the soundproof cell 18A and the respective side plates 28 can be fixed to each other so as to be in close contact with each other.

In the case of moving the soundproof cell 18A, instead of making the film surface of the soundproof cell 18A and the wall surface of the tubular body 22 be parallel to each other, the distance D between the center of the wall surface of the tubular body 22 and the film surface of the film 16c may be adjusted, and then the film surface of the soundproof cell 18A may be inclined by a predetermined angle θ with respect to the wall surface of the tubular body 22 as indicated by a two-dot chain line in FIG. 14. Also in this case, the distance between the wall surface of the tubular body 22 and the film surface of the film 16c is the distance D shown in FIG. 14 since the distance between the wall surface of the tubular body 22 and the film surface of the film 16c is an average value.

In the distance adjusting mechanism 24 described above, the round seat hexagonal nuts 30 are used, but the present invention is not limited thereto, and any shape of a seat nut may be used as long as both the side surfaces of the frame 14A of the soundproof cell 18A can be fixed to the side plate 28 so as to be in close contact with each other. Although the screws 26 are attached to both the side surfaces of the frame 14A, the present invention is not limited thereto. As long as both the side surfaces of the frame 14A can be fixed to the respective side plates 28 so as to be in close contact with each other, screw holes may be provided on both the side surfaces of the frame 14A of the soundproof cell 18A, and seat bolts screwed into female screws in the screw holes may be used instead of the screws 26 and the nuts 30. As a distance adjusting mechanism used in the present invention, a (for example, expandable) holding member whose length can be adjusted may be used. For example, a spacer may be used which has a rod-shaped female screw member having a screw hole of a female screw and a rod-shaped male screw member on which a male screw is formed. In the spacer with a distance adjusting mechanism, the height can be adjusted by screwing the male screw of the male screw member into the female screw of the female screw member.

Since the soundproof structure according to the embodiment of the present invention is basically configured as described above, the following effects can be obtained.

In the soundproof structure according to the embodiment of the present invention, in the soundproof structure in which the sound absorbing body is disposed in the opening portion such as a duct, the separation distance between the inner wall surface of the opening portion and the film surface of the sound absorbing body can be a distance according to the cutoff frequency of the sound to be soundproofed that passes through the opening portion.

In the soundproof structure according to the embodiment of the present invention, in the soundproof structure in which the sound absorbing body is disposed in the opening portion such as a duct, the cutoff frequency of the sound to be soundproofed that passes through the opening portion can be controlled depending on the distance between the inner wall surface of the opening portion and the film surface of the sound absorbing body.

In the soundproof structure according to the embodiment of the present invention, even with a small gap, it is possible to obtain a new effect that larger sound absorbing characteristics than in a structure in which one side is in close contact with the wall surface can be obtained.

Here, in a case where the material and size of each component of the soundproof structure 10 shown in FIGS. 1 and 2 were as follows, a computer simulation was performed in which a plane wave from a speaker was made incident from one opening 22a of the tubular body 22 of the soundproof structure 10 and sound (sound pressure) emitted from the other opening 22a was measured by a microphone. This simulation was performed while changing the distance between the wall surface on the inner peripheral side of the tubular body 22 (hereinafter, also referred to as a bottom wall surface) and the film 16a of the soundproof cell 18. From the experimental results, the sound absorbing characteristics (absorbance with respect to frequency (Hz)) of the soundproof structure 10 in the case of changing the distance between the bottom wall surface of the tubular body 22 and the film 16a of the soundproof cell 18 were obtained.

The frame 14 of the soundproof cell 18 of the soundproof structure 10 is formed of acrylic. The length of one side of a square in a plan view of the hole portion 12 of the frame 14 is 30 mm, the width of the frame 14 is 2 mm, and the height (or the thickness) of the frame 14A is 20 mm. The film 16 (16a and 16b) fixed to both end surfaces of the hole portion 12 of the frame 14 is formed of polyethylene terephthalate (PET) having a thickness of 180 μm. The tubular body 22 is formed of acrylic, and the size of the opening 22a is 60 mm high×68 mm wide.

The distance between the bottom wall surface of the tubular body 22 and the film surface of the film 16a of the soundproof cell 18 was changed from 0 mm (close contact) and 0.1 mm to 20 mm.

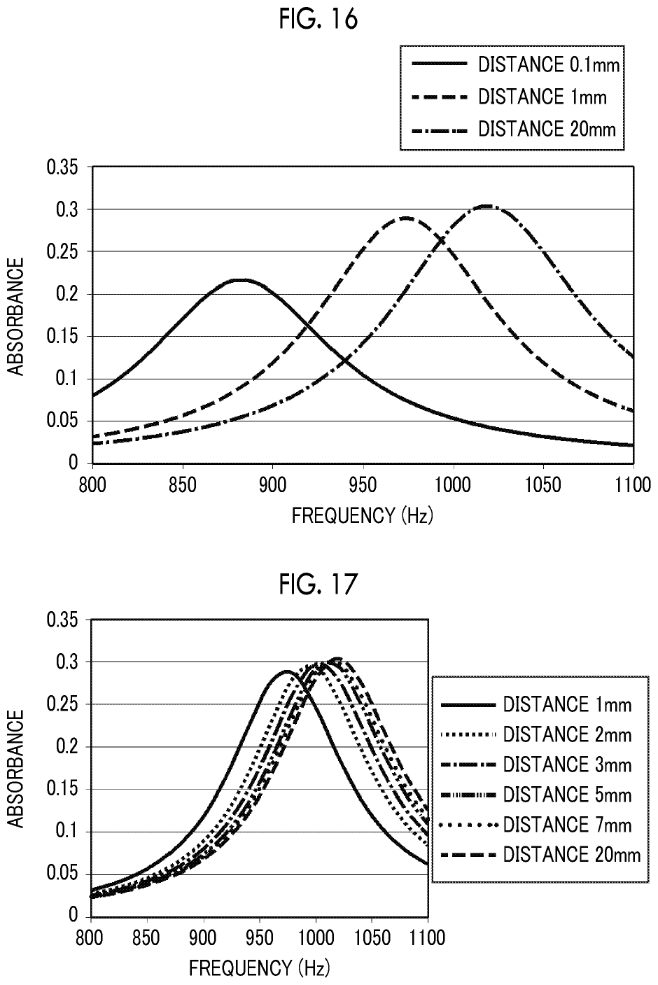

The results obtained as described above are shown in FIGS. 16 and 17 and Table 1.

Here, FIG. 16 is a graph showing an example of the relationship between the frequency and the absorbance in the case of changing the distance (separation distance) between the wall surface of the opening portion (tubular body 22) and the film surface of the film (16a) of the soundproof cell (18) to 0.1 mm, 1 mm, and 20 mm (disposed at the center) by performing adjustment using different pins with a length of 1 mm in diameter, which have no acoustic influence, as a holding member in the soundproof structure according to the embodiment of the present invention.

FIG. 17 is a graph showing an example of the relationship between the frequency and the absorbance in the case of changing the distance (separation distance) between the wall surface of the opening portion (tubular body 22) and the film surface of the film (16a) of the soundproof cell (18) to 1 mm, 2 mm, 3 mm, 5 mm, 7 mm, and 20 mm (disposed at the center) by performing adjustment using different pins with a length of 1 mm in diameter, which have no acoustic influence, as a holding member in the soundproof structure according to the embodiment of the present invention.

Table 1 shows a maximum absorbance at which the absorbance is the greatest at each separation distance in the graph shown in FIG. 17 and an absorption peak frequency indicating the maximum absorbance.

From FIGS. 16 and 17 and Table 1, it can be seen that the absorption peak frequency is lowered by 20 Hz or more by changing the separation distance from 20 mm (disposed at the center) to 3 mm or less. Therefore, in order to lower the absorption peak frequency, it is desirable that the separation distance be short.

TABLE 1

| | Distance (mm) | | | | | |
|---|---|---|---|---|---|---|
| | | | | | | 20 |
| | 1 | 2 | 3 | 5 | 7 | (center) |
| Absorption | 975 | 995 | 1000 | 1020 | 1020 | 1020 |
| peak frequency | | | | | | |
| (Hz) | | | | | | |
| Maximum | 0.29 | 0.30 | 0.30 | 0.29 | 0.30 | 0.30 |
| absorbance | | | | | | |

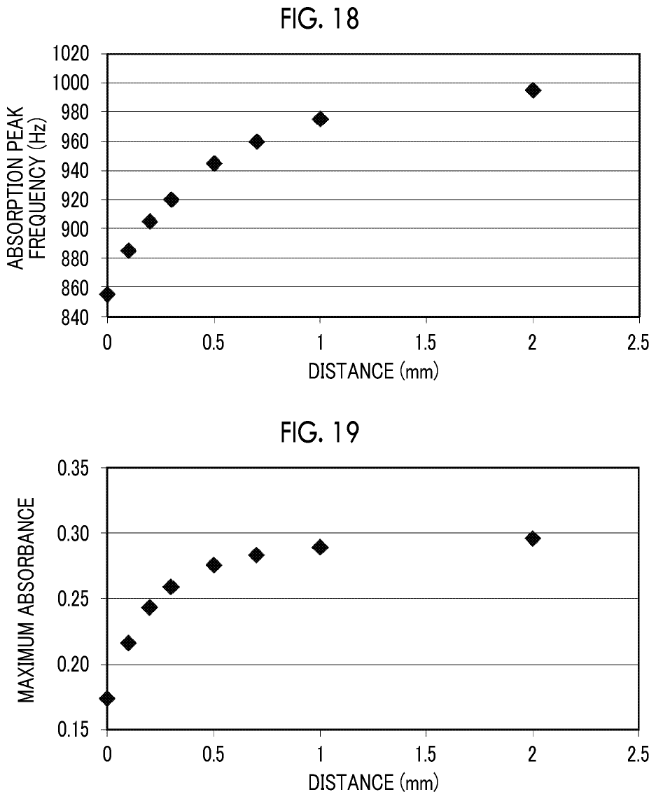

Therefore, the results obtained in a case where the separation distance is 2 mm or less are shown in FIGS. 18 and 19 and Table 2.

FIG. 18 is a graph showing an absorption peak frequency indicating the maximum absorbance in the case of changing the distance (separation distance) between the wall surface of the opening portion (tubular body 22) and the film surface of the film (16a) of the soundproof cell (18) to 0 mm (close contact), 0.1 mm, 0.2 mm, 0.3 mm, 0.5 mm, 0.7 mm, 1 mm, and 2 mm in the soundproof structure according to the embodiment of the present invention.

FIG. 19 is a graph showing a maximum absorbance in the case of changing the distance (separation distance) between the wall surface of the opening portion (tubular body 22) and the film surface of the film (16a) of the soundproof cell (18) to 0 mm (close contact), 0.1 mm, 0.2 mm, 0.3 mm, 0.5 mm, 0.7 mm, 1 mm, and 2 mm in the soundproof structure according to the embodiment of the present invention.

Table 2 shows a maximum absorbance at which the absorbance is the greatest at each separation distance in the graph shown in FIGS. 18 and 19 and an absorption peak frequency indicating the maximum absorbance.

TABLE 2

| | Distance (mm) | | | | | | | |
|---|---|---|---|---|---|---|---|---|
| | 0(close | | | | | | | |
| | contact) | 0.1 | 0.2 | 0.3 | 0.5 | 0.7 | 1 | 2 |
| Absorption peak | 855 | 885 | 905 | 920 | 945 | 960 | 975 | 995 |
| frequency (Hz) | | | | | | | | |
| Maximum absorbance | 0.17 | 0.22 | 0.24 | 0.26 | 0.28 | 0.28 | 0.29 | 0.30 |

From FIGS. 16 to 19 and Tables 1 and 2, it can be seen that the absorbance in a case where the separation distance is only 0.1 mm (that is, in a case where the film surface of the film 16a is slightly separated from the wall surface of the tubular body 22) is higher than that in a case where the separation distance is 0 mm (that is, in a case where the film surface of the film 16a on the wall surface side of the tubular body 22 in the double-sided film 16 (16a and 16b) is in close contact with the wall surface of the tubular body 22).

In addition, from FIGS. 16 to 19 and Tables 1 and 2, it can be seen that, as the separation distance decreases from 20 mm to 0.1 mm, the absorbance decreases slightly but the absorption peak frequency indicating the maximum absorbance decreases from 1020 Hz to 885 Hz.

In particular, from FIGS. 17 to 19 and Tables 1 and 2, it can be seen that, in a case where the separation distance is 0.1 mm to 1.0 mm, as the separation distance decreases, the maximum absorbance decreases but the absorption peak frequency decreases greatly. In addition, it can be seen that, in a case where the separation distance is 1.0 mm to 3.0 mm, both the maximum absorbance and the absorption peak frequency hardly change.

Next, the effect in the case of using the plate-shaped spacers 20A and 20B shown in FIGS. 7 to 12 was examined.

First, as shown in FIG. 11, the spacer 20A having a height of 1 mm, a length of 34 mm, and a thickness of 2 mm (represented by the spacer 20A since the spacer 20B also has the same dimension) was attached to the three sides (portion equivalent to the frame 14) of the film 16a of the soundproof cell 18 having the above-described shape, dimension, and material so as to be fixed to the wall surface of the tubular body 22, thereby manufacturing the soundproof structure according to the embodiment of the present invention. The same experiment as the above-described experiment was performed with a gap of one side, to which the spacer 20A was not attached, on the upstream side in the traveling direction of the sound (plane wave), and the soundproofing characteristics (frequency characteristics) of the soundproof structure were measured.

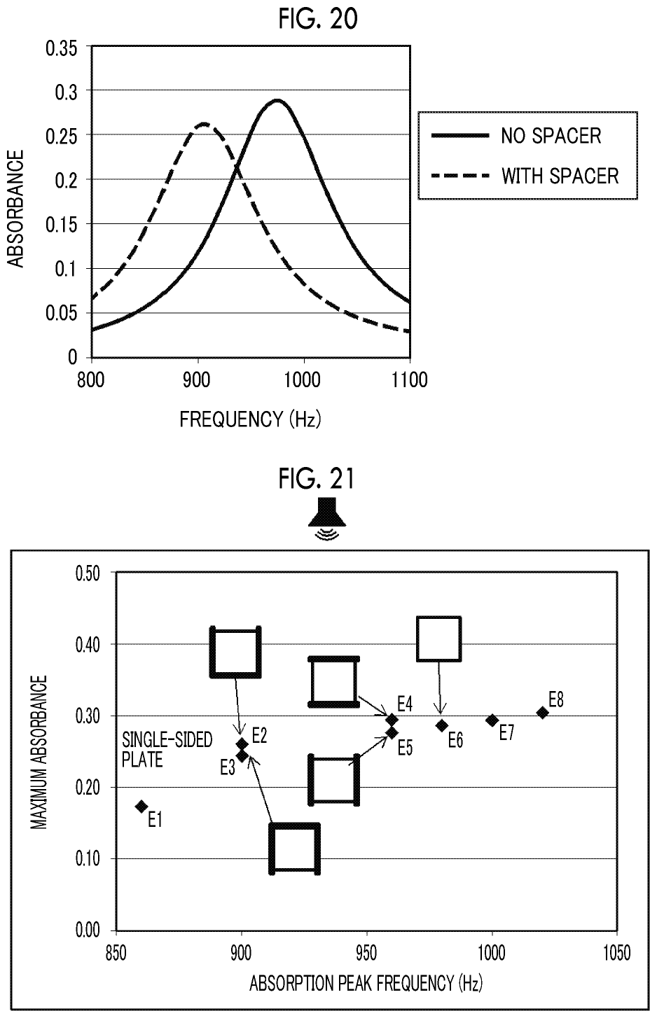

The measurement results are shown in FIG. 20.

FIG. 20 is a graph that shows the soundproofing characteristics (relationship between the absorbance and the frequency (Hz)) in a case where the spacer 20A is attached to the three sides of the film 16a of the soundproof cell 18 (in the case of “with a spacer”) as in this experiment using a dotted line and shows the soundproofing characteristics in a case where the plate-shaped spacer 20A is not used unlike in the above-described experiment and a pin with a diameter of 1 mm having no acoustic influence is used (in the case of “no spacer”) using a solid line. The case of “with a spacer” corresponds to the soundproof structure shown in FIG. 11, and the case of “no spacer” corresponds to a case where a pin with a diameter of 1 mm having no acoustic influence is used in FIGS. 1 and 2.

From FIG. 20, it can be seen that, in the case of “with a spacer”, the maximum absorbance decreases slightly but the absorption peak frequency reliably decreases. That is, it can be seen that the frequency is lowered by fixing the surface of the film 16a of the soundproof cell 18 to the wall surface of the tubular body 22 through the spacer even in a case where the separation distance from the wall surface of the tubular body 22 does not change.

Subsequently, the soundproofing characteristics (frequency characteristics) of soundproofing structures E1 to E8 shown below were measured.

The soundproof structure E1 is a soundproof structure in which one surface of the hole portion 12 of the frame 14 of the soundproof cell 18 is the film 16 and the other surface is a plate-shaped body (single-sided plate), the single-sided plate faces the wall surface of the tubular body 22, and the separation distance is 1 mm.

The soundproof structure E2 is a soundproof structure corresponding to FIG. 11 described above, and is a soundproof structure in which the plate-shaped spacer 20A is attached to the three sides of the film 16a of the soundproof cell 18, the gap of one side to which the spacer 20A is not attached is directed to the upstream side in the traveling direction of the sound, and the separation distance is 1 mm.

The soundproof structure E3 is a soundproof structure corresponding to FIG. 12, and is a soundproof structure which has the same structure of attaching the spacer 20A as in the soundproof structure E2 and in which the gap of one side to which the spacer 20A is not attached is directed to the downstream side in the traveling direction of the sound and the separation distance is 1 mm.

The soundproof structure E4 is a soundproof structure corresponding to FIG. 10, and is a soundproof structure in which the plate-shaped spacer 20A is attached to two opposite sides of the film 16a of the soundproof cell 18, the spacer 20A faces the traveling direction of the sound, and the separation distance is 1 mm.

The soundproof structure E5 is a soundproof structure corresponding to FIG. 9, and is a soundproof structure in which the plate-shaped spacer 20A is attached to two opposite sides of the film 16a of the soundproof cell 18, two sides to which the spacer 20A is not attached are directed in the traveling direction of the sound, and the separation distance is 1 mm.

The soundproof structures E6, E7, and E8 are soundproof structures corresponding to FIG. 1. Although not shown, each of the soundproof structures E6, E7, and E8 is a structure in which a pin with a predetermined diameter of 1 mm is provided at the four corners of the frame while maintaining the distance therebetween so as to be less affected acoustically and the separation distance is 1 mm, 2 mm, and 20 mm.

The relationship between the absorption peak frequency (Hz) and the maximum absorbance in the soundproof structures E1 to E8 is shown in FIG. 21. In FIG. 21, points representing the absorption peak frequency (Hz) and the maximum absorbance in the soundproof structures E1 to E8 are denoted by reference numerals E1 to E8, and explanatory diagrams and descriptions are also attached for reference.

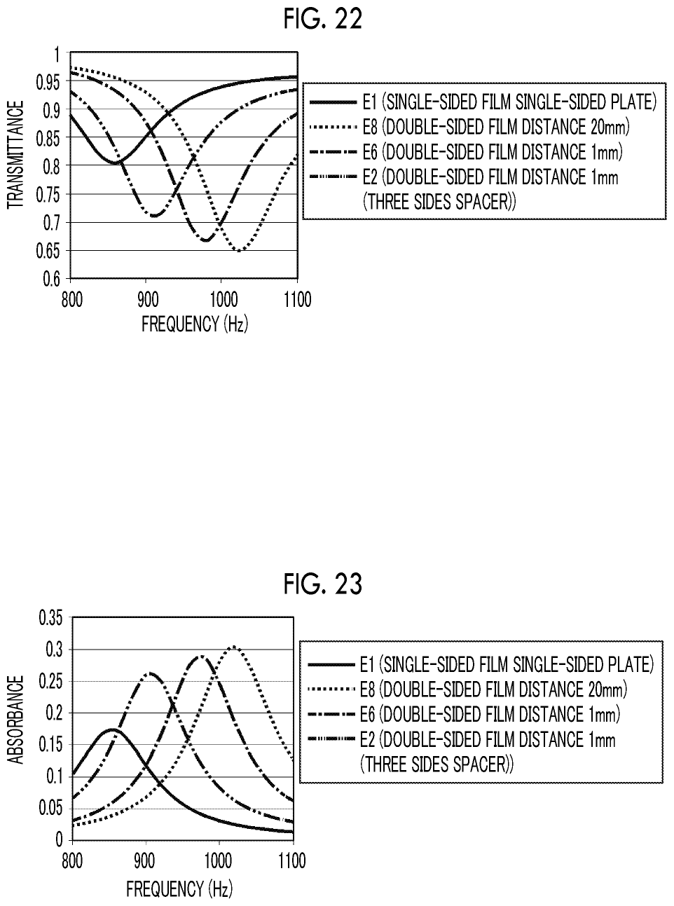

FIG. 22 shows the frequency characteristics of the transmittance of the soundproof structures E1, E2, E6, and E8, and FIG. 23 shows the frequency characteristics of the absorbance of the soundproof structures E1, E2, E6, and E8.

The following can be understood from FIGS. 21 to 23.

As in the case of the soundproof structure E1, in the case of a single-sided plate and a single-sided film, it can be seen that the absorption peak frequency is low but the maximum absorbance is significantly low and the transmittance is significantly high. That is, it can be seen that the soundproof structure of the double-sided film has a larger absorbance and a lower transmittance than the soundproof structure of the single-sided plate and the single-sided film.

It can be seen that the absorption peak frequency decreases as the number of spacers attached to the film of the soundproof cell increases, as in the soundproof structures E2 to E6.

In addition, in a case where the number of spacers attached to the film of the soundproof cell is the same, it can be seen that the absorbance is larger in a case where the spacer is on the opposite side (that is, the downstream side in the traveling direction) to the sound incidence side (upstream side in the traveling direction).

In the examples shown in FIGS. 3 to 15, the distance between the wall surface of the opening portion (tubular body) and the surface of the film (film on the wall surface side) of the soundproof cell is secured by using the spacer. However, the present invention is not limited thereto. In a case where the wall surface of the opening portion is a shape having a corner portion or a curved portion (for example, a polygon, a circle, or an ellipse), films of one or more soundproof cells on the wall surface side may be disposed so as to straddle the corner portion or the curved portion of the wall surface, so that the distance between the films is secured.

Hereinafter, the physical properties or characteristics of a structural member that can be combined with the soundproof structure according to the embodiment of the present invention will be described.

[Flame Retardance]

In the case of using a soundproof structure having the soundproof structure according to the embodiment of the present invention as a soundproof material in a building or a device, flame retardance is required.

Therefore, the film is preferably flame retardant. As the film, for example, Lumirror (registered trademark) nonhalogen flame-retardant type ZV series (manufactured by Toray Industries, Inc.) that is a flame-retardant PET film, Teijin Tetoron (registered trademark) UF (manufactured by Teijin Ltd.), and/or Dialamy (registered trademark) (manufactured by Mitsubishi Plastics Co., Ltd.) that is a flame-retardant polyester film may be used.

The frame is also preferably a flame-retardant material. A metal such as aluminum, an inorganic material such as ceramic, a glass material, flame-retardant polycarbonate (for example, PCMUPY 610 (manufactured by Takiron Co., Ltd.)), and/or flame-retardant plastics such as flame-retardant acrylic (for example, Acrylite (registered trademark) FR1 (manufactured by Mitsubishi Rayon Co., Ltd.)) can be mentioned.

As a method of fixing the film to the frame, a bonding method using a flame-retardant adhesive (Three Bond 1537 series (manufactured by Three Bond Co. Ltd.)) or solder or a mechanical fixing method, such as interposing a film between two frames so as to be fixed therebetween, is preferable.

[Heat Resistance]

There is a concern that the soundproofing characteristics may be changed due to the expansion and contraction of the structural member of the soundproof structure according to the embodiment of the present invention due to an environmental temperature change. Therefore, the material forming the structural member is preferably a heat resistant material, particularly a material having low heat shrinkage.

As the film, for example, Teijin Tetoron (registered trademark) film SLA (manufactured by Teijin DuPont), PEN film Teonex (registered trademark) (manufactured by Teijin DuPont), and/or Lumirror (registered trademark) off-anneal low shrinkage type (manufactured by Toray Industries, Inc.) are preferably used. In general, it is preferable to use a metal film, such as aluminum having a smaller thermal expansion factor than a plastic material.

As the frame, it is preferable to use heat resistant plastics, such as polyimide resin (TECASINT 4111 (manufactured by Enzinger Japan Co., Ltd.)) or glass fiber reinforced resin (TECAPEEKGF 30 (manufactured by Enzinger Japan Co., Ltd.)) or to use a metal such as aluminum, an inorganic material such as ceramic, or a glass material.

As the adhesive, it is preferable to use a heat resistant adhesive (TB 3732 (manufactured by Three Bond Co., Ltd.), super heat resistant one component shrinkable RTV silicone adhesive sealing material (manufactured by Momentive Performance Materials Japan Ltd.) and heat resistant inorganic adhesive Aron Ceramic (registered trademark) (manufactured by Toagosei Co., Ltd.)). In the case of applying these adhesives to a film or a frame, it is preferable to set the thickness to 1 μm or less so that the amount of expansion and contraction can be reduced.

[Weather Resistance and Light Resistance]

In a case where the soundproof structure having the soundproof structure according to the embodiment of the present invention is disposed outdoors or in a place where light is incident, the weather resistance of the structural member becomes a problem.

Therefore, as a film, it is preferable to use a weather-resistant film, such as a special polyolefin film (ARTPLY (trademark) (manufactured by Mitsubishi Plastics Inc.)), an acrylic resin film (ACRYPRENE (manufactured by Mitsubishi Rayon Co.)), and Scotch Calfilm (trademark) (manufactured by 3M Co.).

As a frame member, it is preferable to use plastics having high weather resistance such as polyvinyl chloride, polymethyl methacryl (acryl), metal such as aluminum, inorganic materials such as ceramics, or glass materials.

As an adhesive, it is preferable to use epoxy resin based adhesives and highly weather-resistant adhesives such as Dry Flex (manufactured by Repair Care International).

Regarding moisture resistance as well, it is preferable to appropriately select a film, a frame, and an adhesive having high moisture resistance. Regarding water absorption and chemical resistance, it is preferable to appropriately select an appropriate film, frame, and adhesive.

[Dust]

During long-term use, dust may adhere to the film surface to affect the soundproofing characteristics of the soundproof structure according to the embodiment of the present invention. Therefore, it is preferable to prevent the adhesion of dust or to remove adhering dust.

As a method of preventing dust, it is preferable to use a film formed of a material to which dust is hard to adhere. For example, by using a conductive film (Flecria (registered trademark) (manufactured by TDK Corporation) and NCF (Nagaoka Sangyou Co., Ltd.)) so that the film is not charged, it is possible to prevent adhesion of dust due to charging. It is also possible to suppress the adhesion of dust by using a fluororesin film (Dynoch Film (trademark) (manufactured by 3M Co.)), and a hydrophilic film (Miraclain (manufactured by Lifegard Co.)), RIVEX (manufactured by Riken Technology Inc.) and SH2CLHF (manufactured by 3M Co.)). By using a photocatalytic film (Raceline (manufactured by Kimoto Corporation)), contamination of the film can also be prevented. A similar effect can also be obtained by applying a spray having the conductivity, hydrophilic property, and photocatalytic property or a spray containing a fluorine compound to the film.

In addition to using the above special films, it is also possible to prevent contamination by providing a cover on the film. As the cover, it is possible to use a thin film material (Saran Wrap (registered trademark) or the like), a mesh having a mesh size not allowing dust to pass therethrough, a nonwoven fabric, a urethane, an airgel, a porous film, and the like.

As a method of removing adhering dust, it is possible to remove dust by emitting sound having the resonance frequency of a film and strongly vibrating the film. The same effect can be obtained even in a case where a blower or wiping is used.

[Wind Pressure]

In a case where a strong wind hits a film, the film may be pressed to change the resonance frequency. Therefore, by covering the film with a nonwoven fabric, urethane, or a film, the influence of wind can be suppressed.

In the soundproof structure according to the embodiment of the present invention, in order to suppress the influence (wind pressure on the film, wind noise) due to turbulence caused by blocking the wind on the side surface of the soundproof structure, it is preferable to provide a flow control mechanism, such as a flow straightening plate for rectifying wind W, on the side surface of the soundproof structure.

[Combination of Unit Cells]

The soundproof structure 10 according to the embodiment of the present invention shown in FIGS. 1 and 2 includes one soundproof cell 18 as a unit cell having one frame 14 and one film 16 attached thereto. However, in the soundproof structure according to the embodiment of the present invention, a plurality of unit cells may be used. In this case, a plurality of unit cells may be used independently according to the target frequency, or the separation distance from the wall surface of the opening portion may be changed for each unit cell. On the other hand, the soundproof structure according to the embodiment of the present invention may include a plurality of soundproof cells integrated in advance that has one frame body, in which a plurality of frames are continuous, and a sheet-shaped film body, in which a plurality of films attached to hole portions of the plurality of frames of the one frame body are continuous. Thus, the soundproof structure according to the embodiment of the present invention may be a soundproof structure in which a unit cell is used independently, or may be a soundproof structure in which a plurality of soundproof cells are integrated in advance, or may be a soundproof structure including a plurality of soundproof cells used by connecting a plurality of unit cells to each other. In the soundproof structure in which a plurality of unit cells are connected and integrated, different unit cells may be used as a plurality of unit cells according to the target frequency. In this case, the separation distance from the wall surface of the opening portion may be changed for each unit cell.

As a method of connecting a plurality of unit cells to each other, a Magic Tape (registered trademark), a magnet, a button, a suction cup, or an uneven portion may be attached to a frame so as to be combined therewith, or a plurality of unit cells can be connected to each other using a tape or the like.

[Arrangement]

In order to allow the soundproof cell provided in the soundproof structure according to the embodiment of the present invention to be easily attached to a wall or the like or to be removable therefrom, a detaching mechanism formed of a magnetic material, a Magic Tape (registered trademark), a button, a suction cup, or the like is preferably attached to the soundproof cell of the soundproof structure or a holding member, such as a spacer.

[Mechanical Strength of Frame]

As the size of the soundproof structure according to the embodiment of the present invention increases, the frame easily vibrates, and a function as a fixed end with respect to film vibration is degraded. Therefore, it is preferable to increase the frame stiffness by increasing the thickness of the frame. However, increasing the thickness of the frame causes an increase in the mass of the soundproof structure. This declines the advantage of the present soundproof structure that is lightweight.

Therefore, in order to reduce the increase in mass while maintaining high stiffness, it is preferable to form a hole or a groove in the frame.

In addition, by changing or combining the frame thickness in the plane, it is possible to secure high stiffness and to reduce the weight. In this manner, it is possible to achieve both high stiffness and light weight.

The soundproof structure according to the embodiment of the present invention can be used as the following soundproof structures.

For example, as soundproof structures having the soundproof structure according to the embodiment of the present invention, it is possible to mention: a soundproof structure for building materials (soundproof structure used as building materials); a soundproof structure for air conditioning equipment (soundproof structure installed in ventilation openings, air conditioning ducts, and the like to prevent external noise); a soundproof structure for external opening portion (soundproof structure installed in the window of a room to prevent noise from indoor or outdoor); a soundproof structure for ceiling (soundproof structure installed on the ceiling of a room to control the sound in the room); a soundproofing member for floor (soundproof structure installed on the floor to control the sound in the room); a soundproof structure for internal opening portion (soundproof structure installed in a portion of the inside door or sliding door to prevent noise from each room); a soundproof structure for toilet (soundproof structure installed in a toilet or a door (indoor and outdoor) portion to prevent noise from the toilet); a soundproof structure for balcony (soundproof structure installed on the balcony to prevent noise from the balcony or the adjacent balcony); an indoor sound adjusting member (soundproof structure for controlling the sound of the room); a simple soundproof chamber member (soundproof structure that can be easily assembled and can be easily moved); a soundproof chamber member for pet (soundproof structure that surrounds a pet's room to prevent noise); amusement facilities (soundproof structure installed in a game centers, a sports center, a concert hall, and a movie theater); a soundproof structure for temporary enclosure for construction site (soundproof structure that covers the construction site to prevent leakage of noise around the construction site); and a soundproof structure for tunnel (soundproof structure installed in a tunnel to prevent noise leaking to the inside and outside the tunnel).

While the soundproof structure according to the embodiment of the present invention has been described in detail with reference to various embodiments and examples, the present invention is not limited to these embodiments and examples, and various improvements or modifications may be made without departing from the scope and spirit of the present invention.

### EXPLANATION OF REFERENCES

10, 10A, 10B, 10C: soundproof structure
12, 12A: hole portion
14, 14A: frame
16, 16a, 16b, 16c, 16d, 16A: film
18, 18A: soundproof cell
20, 20A, 20B: spacer
22, 32: tubular body
22a: opening
22b: opening cross section
24: distance adjusting mechanism
26: screw
28: side plate
28a: long hole
30: nut

What is claimed is:

1. A soundproof structure, comprising:
a soundproof cell including a frame having a hole portion penetrating through both opposite surfaces and at least one film fixed to at least one surface of the frame,
wherein the soundproof cell is disposed in an opening portion of a wall separating two spaces from each other in a state in which a surface of the at least one film is inclined with respect to an opening cross section of the opening portion to provide a ventilation portion,
a surface of a film on a side of a wall surface of the opening portion in the at least one film has a portion separated from the wall surface, and
a distance between the surface of the film on the side of the wall surface of the opening portion and the wall surface is 0.1 mm or more and is a distance set according to an absorption peak frequency at a spectral peak of soundproofing.

2. The soundproof structure according to claim 1,
wherein the distance between the surface of the film on the side of the wall surface of the opening portion and the wall surface is 20 mm or less.

3. The soundproof structure according to claim 1,
wherein the at least one film is two films fixed to both surfaces of the frame.

4. The soundproof structure according to claim 2,
wherein the at least one film is two films fixed to both surfaces of the frame.

5. The soundproof structure according to claim 1,
wherein the absorption peak frequency decreases as the distance between the surface of the film on the side of the wall surface of the opening portion and the wall surface decreases.

6. The soundproof structure according to claim 2,
wherein the absorption peak frequency decreases as the distance between the surface of the film on the side of the wall surface of the opening portion and the wall surface decreases.

7. The soundproof structure according to claim 3,
wherein the absorption peak frequency decreases as the distance between the surface of the film on the side of the wall surface of the opening portion and the wall surface decreases.

8. The soundproof structure according to claim 4,
wherein the absorption peak frequency decreases as the distance between the surface of the film on the side of the wall surface of the opening portion and the wall surface decreases.

9. The soundproof structure according to claim 1,
wherein a spacer is provided between the surface of the film on the side of the wall surface of the opening portion and the wall surface,
the soundproof cell is fixed to the wall surface through the spacer, and
the spacer has a gap with at least one portion through which sound from an outside enters.

10. The soundproof structure according to claim 9,
wherein the spacer is a plurality of columnar bodies.

11. The soundproof structure according to claim 9,
wherein sound is incident from one opening end of the opening portion and propagates to exit from the other opening end, and
the spacer is a plurality of plate-shaped bodies.

12. The soundproof structure according to claim 11,
wherein the plate-shaped bodies are disposed so as to face an incidence direction of the sound.

13. The soundproof structure according to claim 11,
wherein the plate-shaped bodies are disposed along an incidence direction of the sound.

14. The soundproof structure according to claim 9,
wherein the spacer and the soundproof cell are formed as an integrated structure.

15. The soundproof structure according to claim 10,
wherein the spacer and the soundproof cell are formed as an integrated structure.

16. The soundproof structure according to claim 11,
wherein the spacer and the soundproof cell are formed as an integrated structure.

17. The soundproof structure according to claim 12,
wherein the spacer and the soundproof cell are formed as an integrated structure.

18. The soundproof structure according to claim 13,
wherein the spacer and the soundproof cell are formed as an integrated structure.

19. The soundproof structure according to claim 1,
wherein the distance between the surface of the film on the side of the wall surface of the opening portion and the wall surface is adjustable.

20. The soundproof structure according to claim 1,
wherein an angle between the surface of the film on the side of the wall surface of the opening portion and the wall surface is adjustable.
